(19) United States
(12) Patent Application Publication
(10) Pub. No.: US 2017/0277104 A1
(43) Pub. Date: Sep. 28, 2017

(54) Image Formation Apparatus

(71) Applicant: Konica Minolta, Inc., Tokyo (JP)

(72) Inventor: Masahiro MATSUO, Tokyo (JP)

(21) Appl. No.: 15/465,159

(22) Filed: Mar. 21, 2017

(30) Foreign Application Priority Data
Mar. 22, 2016 (JP) 2016-057385

(51) Int. Cl. G03G 15/00

(52) U.S. Cl. CPC G03G 15/6529

(57) ABSTRACT

An image formation apparatus is such that at least one of an upstream guide plate and a downstream guide plate is provided with a guide roller that extends in a direction transverse to a direction in which a continuous medium is transported and that rotates on the side of an upper surface of the continuous medium while abutting against the continuous medium in a state where the continuous medium is tensioned.

### CROSS REFERENCE TO RELATED APPLICATIONS

This application is based on Japanese Patent Application(s) No. 2016-057385 filed with the Japan Patent Office on Mar. 22, 2016, the entire content of which is hereby incorporated by reference.

### BACKGROUND OF THE INVENTION

Field of the Invention

The present invention relates to an image formation apparatus which forms an image in an electrophotographic system. An image formation apparatus, regardless of whether it may be a color image formation apparatus or a monochrome image formation apparatus, includes a digital copier, a fax, a printer and a similar electrophotographic device, a recorder, a display device etc.

Description of the Related Art

An image formation apparatus of an electrophotographic system, such as a copier, a printer, a facsimile, and an MFP, supplies an electrostatic latent image formed on a photoreceptor with a developing agent from a developing device to form an image of the developing agent. An electrophotographic image formation apparatus capable of forming an image on a continuous medium may be configured to allow a transport frame including a transport path to be drawn out. The transport frame may have not only the transport path but also a unit of an image forming unit etc. mounted therein.

Note that the continuous medium means a medium larger as a sheet in length than a flat sheet that can be accommodated inside the body of an image formation apparatus (e.g., the A3 size), and includes a drop curtain, a flat sheet for a banner, a rolled sheet, a continuous sheet, and the like for example. The medium includes not only paper but also film and the like including any medium in the form of paper to be printed by the image formation apparatus.

The transport frame is drawn out when the apparatus has a paper jam, undergoes maintenance, has a path cleaned, or the like. Japanese Laid-Open Patent Publication No. 2014-119649 discloses a configuration which has a mechanism which cuts a continuous medium's upstream and downstream in a transport frame when the transport frame is drawn out.

### SUMMARY OF THE INVENTION

In an existing image formation apparatus, when a continuous medium including a pressure sensitive adhesive of a label roll sheet or the like is used, then, except for an image forming roller and a tensioning roller, it is also preferable in view of prevention of meandering that the number of transportation rollers be minimized Normally, to prevent the continuous medium from meandering, inside the image formation apparatus the continuous medium is tensioned, and accordingly, the continuous medium's path will be a shortest path by a roller and a guide plate.

When the continuous medium is tensioned, then, depending on the transport path, an end of the label roll sheet contacts a guide plate provided on the transport path, and the end's glue may adhere to the guide plate. The guide plate has an upper guide plate and a lower guide plate, and the label roll sheet passes through a small gap between the upper guide plate and the lower guide plate.

In particular, when the continuous medium is tensioned, the label roll sheet's glue may adhere to the upper guide plate, which will be a cause of unsatisfactory passing of the sheet. Furthermore, since the gap between the upper guide plate and the lower guide plate is narrow, it is difficult to clean the guide plate.

The present invention has been made in view of the above issue, and an object thereof is to provide an image formation apparatus using a continuous medium, that has a configuration which can facilitate cleaning a guide plate.

To achieve at least one of the above mentioned objects, an image formation apparatus reflecting one aspect of the present invention is an image formation apparatus of an electrophotographic system capable of forming an image on a continuous medium, comprising: a sheet feeding device configured to feed the continuous medium; a winding device configured to wind up the continuous medium fed from the sheet feeding device; and a body of the image formation apparatus configured to form an image on the continuous medium while the continuous medium is transported between the sheet feeding device and the winding device.

The body of the image formation apparatus includes: a transfer device configured to transfer a prescribed toner image to the continuous medium; a fixing device configured to apply heat to fix the toner image transferred to the continuous medium; and a transport frame provided inside the body of the image formation apparatus, including a portion of the transfer device and the fixing device, configuring a portion of a transport path of the continuous medium, and drawable toward a front side of the body of the image formation apparatus.

The transport frame, as seen in the direction in which the continuous medium is transported, has an upstream guide plate which is provided upstream of a portion of the transfer device and sandwiches the continuous medium in upward and downward directions, and a downstream guide plate which is provided downstream of the fixing device and sandwiches the continuous medium in upward and downward directions.

At least one of the upstream guide plate and the downstream guide plate is provided with a guide roller that extends in a direction transverse to the direction in which the continuous medium is transported and that rotates on the side of an upper surface of the continuous medium while abutting against the continuous medium in a state where the continuous medium is tensioned.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a general configuration of an image formation apparatus of an embodiment.

FIG. 2 is a schematic diagram showing an internal configuration of the image formation apparatus of the embodiment.

FIG. 3 is a schematic diagram showing an internal configuration of a transport frame of an embodiment.

FIG. 4 is a schematic diagram showing a configuration of an upstream guide plate of an embodiment.

FIG. 5 is a schematic diagram showing a state where a continuous medium is tensioned in the image formation apparatus of an embodiment.

FIG. 6 is a first figure showing a pattern of disposing an upstream guide plate and a downstream guide plate in the image formation apparatus of an embodiment.

FIG. 7 is a second figure showing a pattern of disposing an upstream guide plate and a downstream guide plate in the image formation apparatus of an embodiment.

FIG. 8 is a third figure showing a pattern of disposing an upstream guide plate and a downstream guide plate in the image formation apparatus of an embodiment.

FIG. 9 is a fourth figure showing a pattern of disposing an upstream guide plate and a downstream guide plate in the image formation apparatus of an embodiment.

FIG. 10 is a fifth figure showing a pattern of disposing an upstream guide plate and a downstream guide plate in the image formation apparatus of an embodiment.

FIG. 11 is a schematic diagram showing a mechanism to open/close locking of a guide roller in the image formation apparatus of an embodiment (in a locked position).

FIG. 12 is a schematic diagram showing the mechanism to open/close locking of the guide roller in the image formation apparatus of the embodiment (in an unlocked position).

FIG. 13 is a schematic diagram showing a ganged rotation mechanism of guide rollers in an image formation apparatus of an embodiment.

### DESCRIPTION OF THE PREFERRED EMBODIMENTS

An image formation apparatus in an embodiment based on the present invention will be described hereinafter with reference to the drawings. Note that in any embodiment described hereafter, when numbers, amounts and the like are referred to, the present invention is not necessarily limited in scope thereto unless otherwise indicated. Identical and corresponding components and parts are identically denoted and may not be described repeatedly. Furthermore, the drawings are not shown in accordance with an actual dimensional ratio, and to help understanding a structure, there is a portion shown with a modified ratio to clarify the structure.

(Image Formation Apparatus 1)

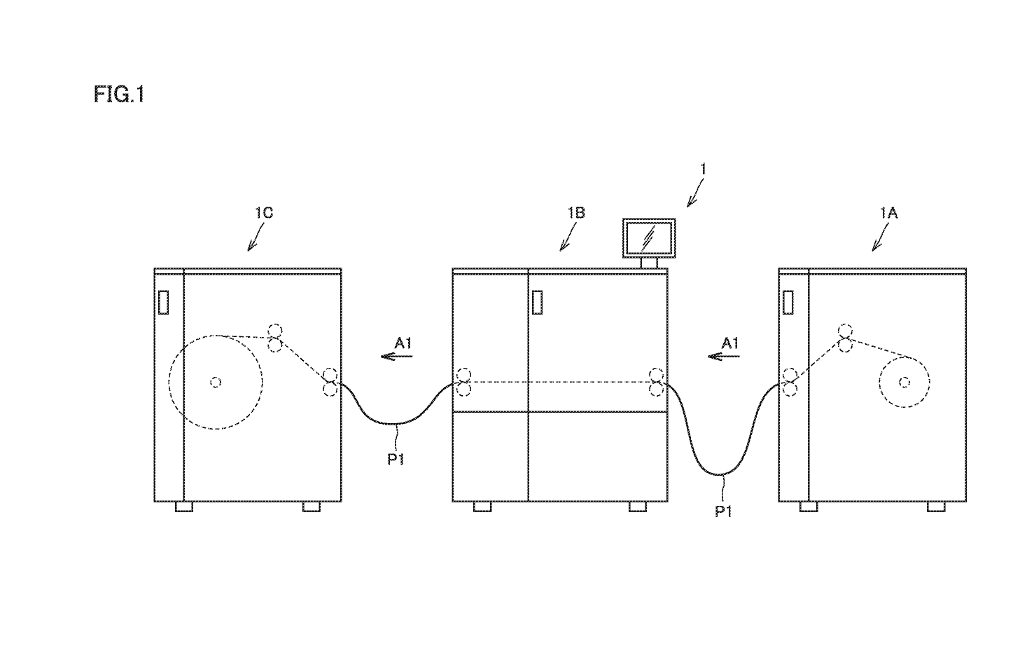

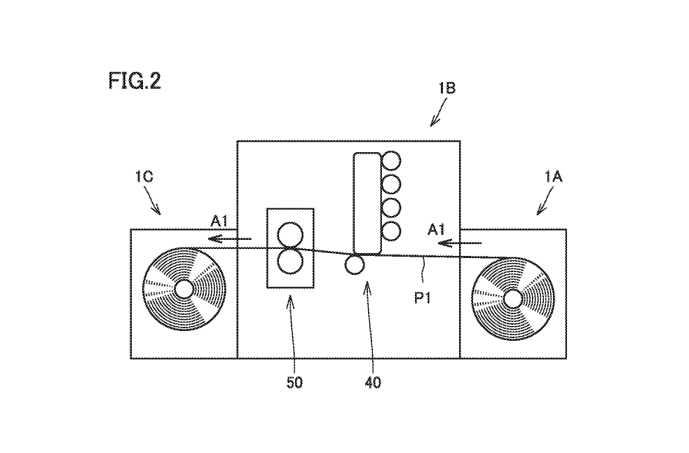

With reference to FIGS. 1 and 2, a schematic configuration of an image formation apparatus 1 in the present embodiment will be described. FIG. 1 is a schematic diagram showing a general configuration of image formation apparatus 1, and FIG. 2 is a schematic diagram showing an internal configuration of the image formation apparatus.

Image formation apparatus 1 includes a sheet feeding device 1A, a main body 1B of the image formation apparatus, and a winding device 1C. Sheet feeding device 1A has a continuous medium P1 wound in the form of a roll, and continuous medium P1, after being fed from sheet feeding device 1A in a feeding direction A1, passes along a transport path through main body 1B of the image formation apparatus, and after a prescribed image is formed, continuous medium P1 is wound up in winding device 1C in the form of a roll.

When continuous medium P1 is transported, it receives tension T, which is adjusted by a rate of sheet feeding device 1A to feed a sheet and a rate of winding device 1C to wind up the sheet. For example, setting the rate of winding device 1C to wind up a sheet to be faster than the rate of sheet feeding device 1A to feed the sheet allows continuous medium P1 to experience larger tension.

Main body 1B of the image formation apparatus is internally provided with a transfer device 40 which transfers a prescribed toner image to continuous medium P1, and a fixing device 50 which applies heat to fix the toner image transferred to continuous medium P1, and they configure a portion of a transport path.

(Transport Frame 100)

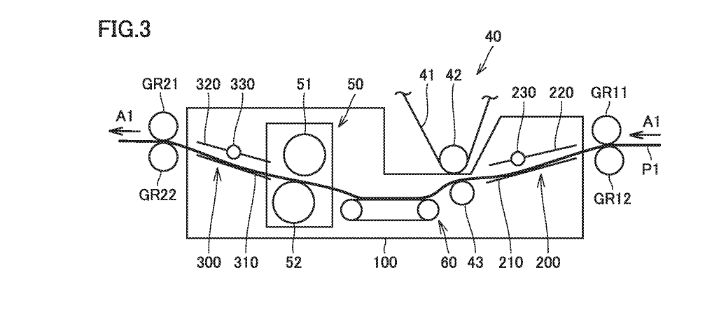

A transport frame 100 will be described with reference to FIG. 3. FIG. 3 is a schematic diagram showing an internal configuration of transport frame 100. Inside main body 1B of the image formation apparatus, transport frame 100 is provided which includes a portion of transfer device 40 and fixing device 50, configures a portion of a transport path of continuous medium P1, and can be drawn out toward a front side of main body 1B of the image formation apparatus. Note that the “front side” as referred to herein indicates a position of a side on which a user who operates image formation apparatus 1 performs an operation using a monitor or the like, and, as seen in FIGS. 1-3, it is a side on which the figures are observed.

Transport frame 100, as seen in a direction in which continuous medium P1 is transported, includes an upstream guide plate 200 which is provided upstream of a portion of transfer device 40 and sandwiches continuous medium P1 in upward and downward directions. A pair of transportation rollers GR11 and GR12 is provided inside main body 1B of the image formation apparatus at an entrance of transport frame 100 for continuous medium P1.

In transport frame 100, downstream of upstream guide plate 200, a transfer belt 41, a transfer roller 42, and a secondary transfer roller 43 which configure a portion of transfer device 40 are located. Secondary transfer roller 43 is provided in transport frame 100.

Downstream of secondary transfer roller 43, a transporting belt 60 is provided. Downstream of transporting belt 60, fixing device 50 is provided. Fixing device 50 includes a fixing, heating roller 51 and a fixing, heating roller 52. Downstream of fixing device 50, a downstream guide plate 300 is provided which sandwiches continuous medium P1 in upward and downward directions. A pair of transportation rollers GR21 and GR22 is provided inside main body 1B of the image formation apparatus at an exit of transport frame 100 for continuous medium P1.

In the present embodiment, as an example, upstream guide plate 200 is provided to have a downstream side inclined downward and downstream guide plate 300 is provided to have a downstream side inclined upward.

When main body 1B of the image formation apparatus internally has a paper jam, undergoes maintenance, has a path cleaned or the like, transport frame 100 is drawn out toward the front side from main body 1B of the image formation apparatus. In doing so, continuous medium P1 in transport frame 100 has an upstream (or a side closer to the entrance) and a downstream (or a side closer to the exit) cut. As a mechanism which cuts continuous medium P1, a mechanism disclosed in Japanese Laid-Open Patent Publication No. 2014-119649 is adopted for example.

(Guide Plate)

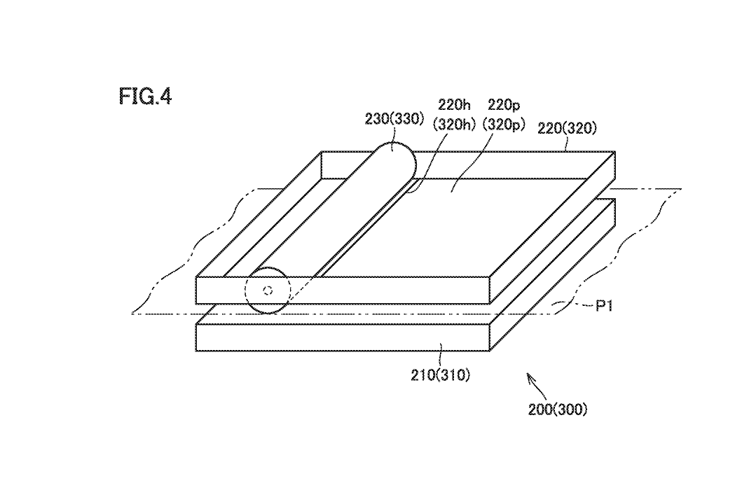

Subsequently, a configuration of the guide plate will be described. Upstream guide plate 200 and downstream guide plate 300 are identical in configuration, and accordingly, with reference to FIG. 4, a configuration of upstream guide plate 200 will be described. FIG. 4 is a schematic diagram showing a configuration of upstream guide plate 200, and in the figure a parenthesized number indicates that for a configuration of downstream guide plate 300.

Upstream guide plate 200 has a lower surface side guide plate 210 (310) located on the side of a lower surface of continuous medium P1, and an upper surface side guide plate 220 (320) located on the side of an upper surface of continuous medium P1. Continuous medium P1 passes between lower surface side guide plate 210 (310) and upper surface side guide plate 220 (320) through a gap of about several millimeters to about 10 mm.

Upper surface side guide plate 220 (320) is provided with a cylindrical guide roller 230 (330) that extends in a direction transverse to a direction in which continuous medium P1 is transported and that rotates while abutting against continuous medium P1 in a state where continuous medium P1 is tensioned. Upper surface side guide plate 220 (320) has a plate portion 220p (320p) provided with an opening 220h (320h), and guide roller 230 (330) can be partially exposed from opening 220h to abut against continuous medium P1.

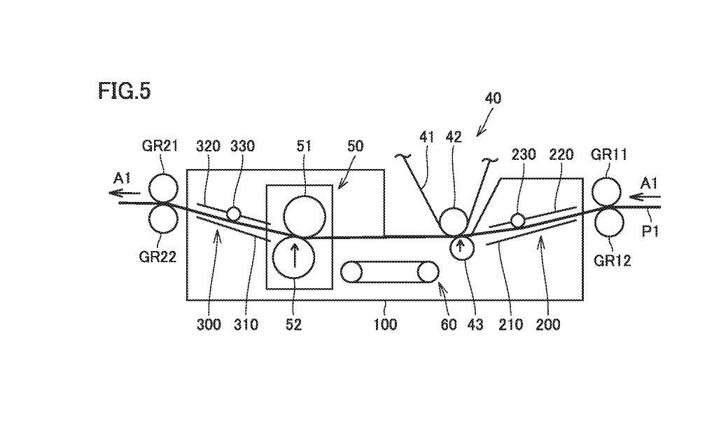

With reference to FIG. 5, a function of guide roller 230 provided in upstream guide plate 200 and guide roller 330 provided in downstream guide plate 300 will be described. FIG. 5 is a schematic diagram showing a state where continuous medium P1 is tensioned in image formation apparatus 1.

In the state where continuous medium P1 is tensioned, transfer device 40 and fixing device 50 operate. In transfer device 40, secondary transfer roller 43 sandwiches continuous medium P1 with transfer roller 42. In fixing device 50, fixing, heating roller 52 sandwiches continuous medium P1 with fixing, heating roller 51. Thus, continuous medium P1 is tensioned and thus passes through a shortest path. Accordingly, continuous medium P1 is pressed against an upper side of upstream guide plate 200 and that of downstream guide plate 300.

In the present embodiment, guide roller 230 is provided in upper surface side guide plate 220 of upstream guide plate 200. Thus, continuous medium P1 passing through upstream guide plate 200 is transported while abutting against guide roller 230. Similarly, guide roller 330 is provided in upper surface side guide plate 320 of downstream guide plate 300, and accordingly, continuous medium P1 passing through downstream guide plate 300 is transported while abutting against guide roller 330.

Thus, continuous medium P1 is transported while abutting against guide rollers 230, 330, so that for example if continuous medium P1 includes a pressure sensitive adhesive such as glue, the guide plates are not smeared with glue and guide rollers 230, 330 will instead be smeared with the pressure sensitive adhesive.

Guide rollers 230, 330 smeared with the pressure sensitive adhesive can be cleaned by drawing out transport frame 100 frontward. Guide roller 230 is provided in upper surface side guide plate 220 of upstream guide plate 200, and accordingly, by drawing out transport frame 100 frontward, guide roller 230 can be externally exposed and thus have a surface easily cleaned. Similarly, guide roller 330 is provided in upper surface side guide plate 320 of downstream guide plate 300, and accordingly, by drawing out transport frame 100 frontward, guide roller 330 can be externally exposed and thus have a surface easily cleaned.

Upstream guide plate 200 shown in FIG. 5 is provided with a single guide roller 230, and similarly, downstream guide plate 300 is also provided with a single guide roller 330. In that case, a portion of upstream guide plate 200 which continuous medium P1 most easily contacts is a downstream side of upstream guide plate 200, and accordingly, it is recommendable to also provide guide roller 230 on the downstream side. Similarly, a portion of downstream guide plate 300 which continuous medium P1 most easily contacts is an upstream side of downstream guide plate 300, and accordingly, it is recommendable to also provide guide roller 330 on the upstream side.

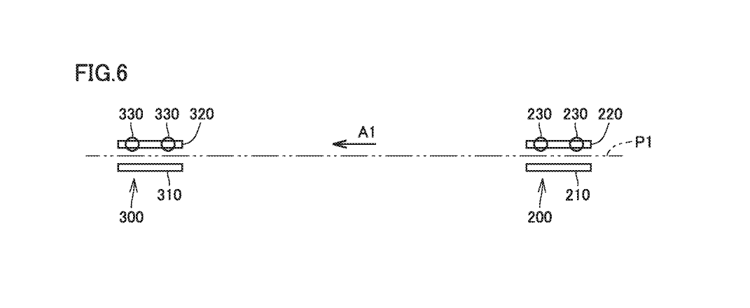

As shown in FIGS. 6-10, upstream guide plate 200 and downstream guide plate 300 may be disposed. FIG. 6 to FIG. 10 are first to fifth figures showing patterns of disposing upstream guide plate 200 and downstream guide plate 300.

While each figure shows a case where upstream guide plate 200 is provided with two guide rollers 230 and downstream guide plate 300 is provided with two guide rollers 330, the number of guide rollers can be changed as appropriate, and as shown in FIG. 3 and FIG. 5, one or two or more guide rollers may be provided.

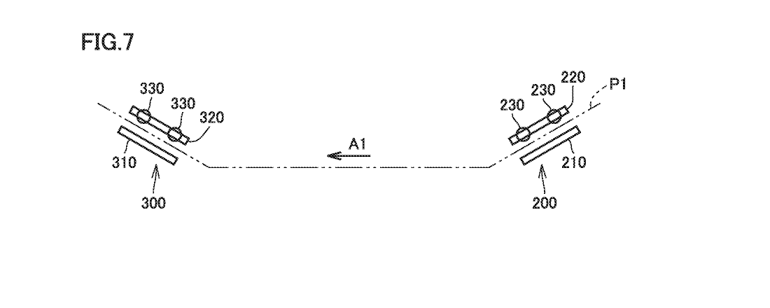

The arrangement pattern shown in FIG. 6 disposes upstream guide plate 200 and downstream guide plate 300 horizontally. The arrangement pattern shown in FIG. 7 is similar to FIG. 3 and FIG. 5, i.e., upstream guide plate 200 is provided to have a downstream side inclined downward and downstream guide plate 300 is provided to have a downstream side inclined upward.

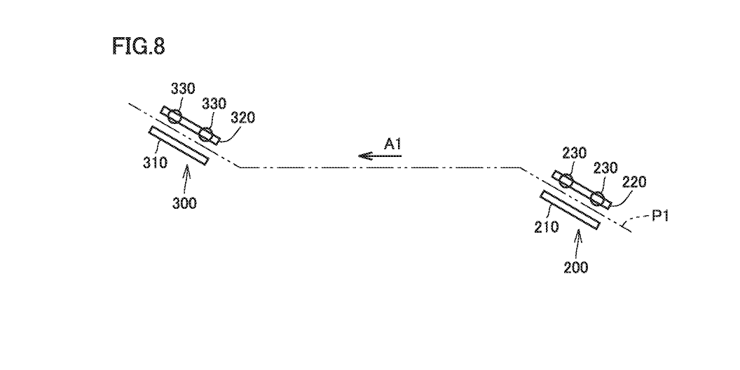

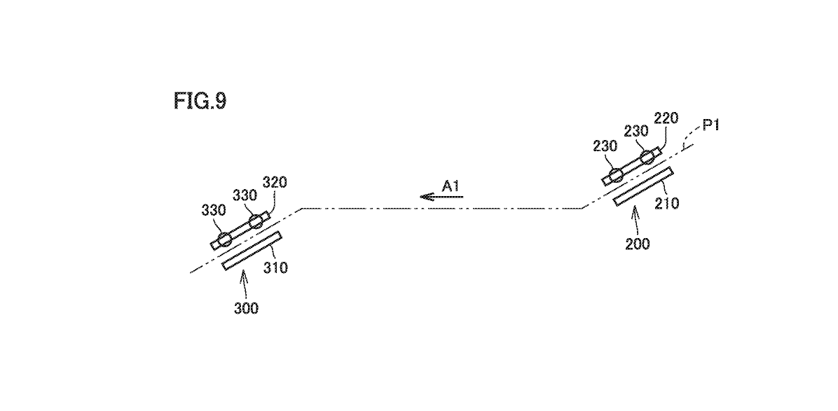

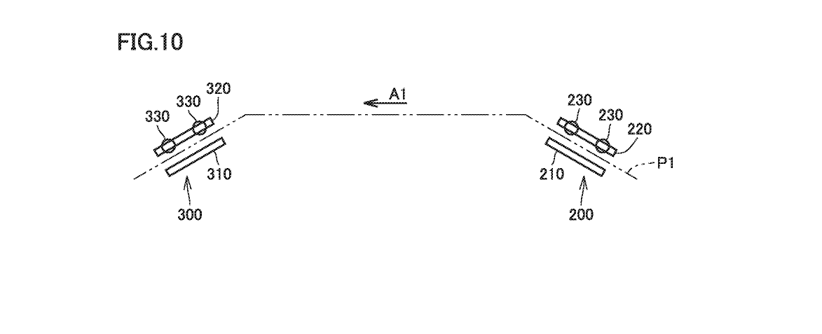

In the arrangement pattern shown in FIG. 8, upstream guide plate 200 is provided to have a downstream side inclined upward and downstream guide plate 300 is provided to have a downstream side inclined upward. In the arrangement pattern shown in FIG. 9, upstream guide plate 200 is provided to have a downstream side inclined downward and downstream guide plate 300 is also provided to have a downstream side inclined downward. In the arrangement pattern shown in FIG. 10, upstream guide plate 200 is provided to have a downstream side inclined upward and downstream guide plate 300 is provided to have a downstream side inclined downward.

These arrangement patterns serve as configurations selected as appropriate based on the internal structure of main body 1B of the image formation apparatus.

(Lock Opening and Closing Mechanism)

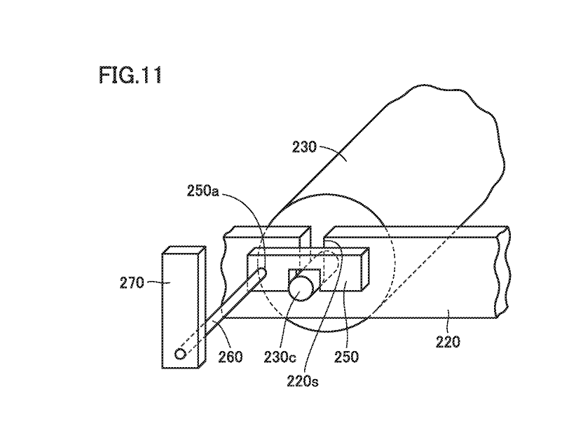

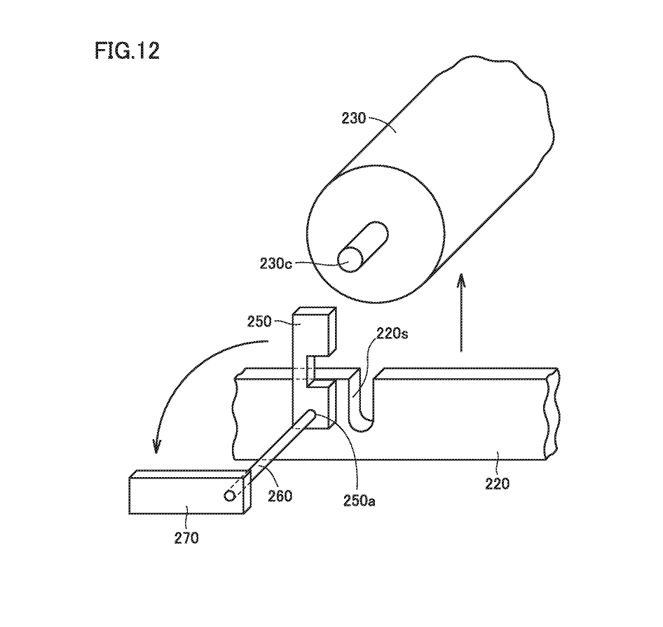

With reference to FIG. 11 and FIG. 12, a lock opening and closing mechanism provided to guide roller 230 will be described. FIG. 11 is a schematic diagram showing a mechanism to open/close locking of guide roller 230 (in a locked position), and FIG. 12 is a schematic diagram showing the mechanism to open/close locking of guide roller 230 (in an unlocked position). Note that guide roller 330 can also be provided with a similar lock opening and closing mechanism, and accordingly, the mechanism will not be described repeatedly.

Guide roller 230 has a rotation shaft 230c. Rotation shaft 230c is rotatably fitted in a slit groove 220s in the form of the letter U provided in upper surface side guide plate 220. A lock member 250 capable of engaging with rotation shaft 230c is attached to upper surface side guide plate 220 rotatably about a center of rotation 250a.

The state shown in FIG. 11 is a state in which lock member 250 engages with rotation shaft 230c to maintain a state of an attachment of guide roller 230 to upper surface side guide plate 220 and guide roller 230 cannot be removed from upper surface side guide plate 220.

The state shown in FIG. 12 is a state in which lock member 250 is rotated counter-clockwise by 90 degrees to cancel a state of an attachment of guide roller 230 done by lock member 250 and guide roller 230 can be extracted from upper surface side guide plate 220.

Coupled with center of rotation 250a of lock member 250 is a ganged rotation shaft 260. Coupled with ganged rotation shaft 260 is a handle 270 used when drawing out transport frame 100 frontward.

In the state shown in FIG. 11, transport frame 100 is accommodated in main body 1B of the image formation apparatus, and handle 270 and ganged rotation shaft 260 maintain a drawing lock mechanism (not shown) of transport frame 100 in a locked position.

In the state shown in FIG. 12, handle 270 and ganged rotation shaft 260 are in a state after they are rotated counter-clockwise by 90 degrees, and the drawing lock mechanism of transport frame 100 has been changed from the locked position to an unlocked position to allow transport frame 100 to be drawn frontward.

Thus, by adopting a configuration in which in the state where transport frame 100 has been drawn out toward the front side of main body 1B of the image formation apparatus, the state of the attachment of guide roller 230 by lock member 250 is cancelled and guide roller 230 can be extracted, whereas in the state where transport frame 100 is accommodated in main body 1B of the image formation apparatus, the state of the attachment of guide roller 230 by lock member 250 is maintained and guide roller 230 cannot be extracted, main body 1B of the image formation apparatus can be safely operated and an operation to exchange guide roller 230 can also be performed safely and easily.

(Ganged Rotation Mechanism)

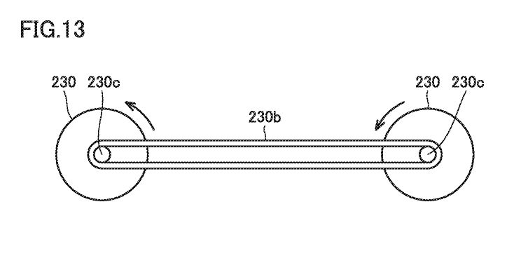

With reference to FIG. 13, a ganged rotation mechanism when two or more guide rollers 230 are provided will be described. FIG. 13 is a schematic diagram showing a ganged rotation mechanism of guide rollers 230. Note that guide roller 330 can also be provided with a similar ganged rotation mechanism, and accordingly, the mechanism will not be described repeatedly.

As the ganged rotation mechanism, a ganging belt 230b is engaged around rotation shafts 230c of guide rollers 230 that are disposed in parallel so that by rotating one guide roller 230, the other guide roller 230 can also be rotated simultaneously. By adopting this ganged rotation mechanism, two or more guide rollers 230 can have a surface cleaned while they are simultaneously rotated, and they can thus be cleaned more efficiently.

The present image formation apparatus is an image formation apparatus of an electrophotographic system capable of forming an image on a continuous medium, comprising: a sheet feeding device configured to feed the continuous medium; a winding device configured to wind up the continuous medium fed from the sheet feeding device; and a body of the image formation apparatus configured to form an image on the continuous medium while the continuous medium is transported between the sheet feeding device and the winding device.

The body of the image formation apparatus includes: a transfer device configured to transfer a prescribed toner image to the continuous medium; a fixing device configured to apply heat to fix the toner image transferred to the continuous medium; and a transport frame provided inside the body of the image formation apparatus, including a portion of the transfer device and the fixing device, configuring a portion of a transport path of the continuous medium, and drawable toward a front side of the body of the image formation apparatus.

The transport frame, as seen in a direction in which the continuous medium is transported, has an upstream guide plate which is provided upstream of a portion of the transfer device and sandwiches the continuous medium in upward and downward directions, and a downstream guide plate which is provided downstream of the fixing device and sandwiches the continuous medium in upward and downward directions.

At least one of the upstream guide plate and the downstream guide plate is provided with a guide roller that extends in a direction transverse to the direction in which the continuous medium is transported and that rotates on the side of an upper surface of the continuous medium while abutting against the continuous medium in a state where the continuous medium is tensioned.

In another form, both the upstream guide plate and the downstream guide plate are provided with the guide roller.

In another form, as seen in the direction in which the continuous medium is transported, the upstream guide plate has an upstream side provided with the guide roller and also has a downstream side provided with the guide roller, and the downstream guide plate has an upstream side provided with the guide roller and also has a downstream side provided with the guide roller.

In another form, the guide roller provided on the upstream side of the upstream guide plate and the guide roller provided on the downstream side of the upstream guide plate are provided such that the guide rollers rotate in a ganged manner, and the guide roller provided on the upstream side of the downstream guide plate and the guide roller provided on the downstream side of the downstream guide plate are provided such that the guide rollers rotate in a ganged manner.

In another form, the upstream guide plate is alone provided with the guide roller.

In another form, the upstream guide plate has an upstream side provided with the guide roller and also has a downstream side provided with the guide roller.

In another form, the guide roller provided on the upstream side of the upstream guide plate and the guide roller provided on the downstream side of the upstream guide plate are provided such that the guide rollers rotate in a ganged manner.

In another form, the downstream guide plate is alone provided with the guide roller.

In another form, the downstream guide plate has an upstream side provided with the guide roller and also has a downstream side provided with the guide roller.

In another form, the guide roller provided on the upstream side of the downstream guide plate and the guide roller provided on the downstream side of the downstream guide plate are provided such that the guide rollers rotate in a ganged manner.

In another form: the guide roller is provided to be detachably attachable using a lock member; in a state where the transport frame is drawn out toward the front side of the body of the image formation apparatus, a state of an attachment of the guide roller by the lock member is cancelled and the guide roller is extractable; and in a state where the transport frame is accommodated in the body of the image formation apparatus, the state of the attachment of the guide roller by the lock member is maintained and the guide roller is unextractable.

While the present invention has been described in embodiments, it should be understood that the embodiments disclosed herein are illustrative and non-restrictive in any respect. The scope of the present invention is defined by the terms of the claims, and is intended to include any modifications within the meaning and scope equivalent to the terms of the claims.

What is claimed is:

1. An electrophotographic image formation apparatus capable of forming an image on a continuous medium, comprising:
a sheet feeding device configured to feed the continuous medium;
a winding device configured to wind up the continuous medium fed from the sheet feeding device; and
a body of the image formation apparatus configured to form an image on the continuous medium while the continuous medium is transported between the sheet feeding device and the winding device,
the body of the image formation apparatus including:
a transfer device configured to transfer a prescribed toner image to the continuous medium;
a fixing device configured to apply heat to fix the toner image transferred to the continuous medium; and
a transport frame provided inside the body of the image formation apparatus, including a portion of the transfer device and the fixing device, configuring a portion of a transport path of the continuous medium, and drawable toward a front side of the body of the image formation apparatus,
the transport frame, as seen in a direction in which the continuous medium is transported, having
an upstream guide plate which is provided upstream of a portion of the transfer device and sandwiches the continuous medium in upward and downward directions, and
a downstream guide plate which is provided downstream of the fixing device and sandwiches the continuous medium in upward and downward directions,
at least one of the upstream guide plate and the downstream guide plate being provided with a guide roller that extends in a direction transverse to the direction in which the continuous medium is transported and that rotates on a side of an upper surface of the continuous medium while abutting against the continuous medium in a state where the continuous medium is tensioned.

2. The image formation apparatus according to claim 1, wherein both the upstream guide plate and the downstream guide plate are provided with the guide roller.

3. The image formation apparatus according to claim 2, wherein, as seen in the direction in which the continuous medium is transported:
the upstream guide plate has an upstream side provided with the guide roller and also has a downstream side provided with the guide roller; and
the downstream guide plate has an upstream side provided with the guide roller and also has a downstream side provided with the guide roller.

4. The image formation apparatus according to claim 3, wherein:
the guide roller provided on the upstream side of the upstream guide plate and the guide roller provided on the downstream side of the upstream guide plate are provided such that the guide rollers rotate in a ganged manner; and
the guide roller provided on the upstream side of the downstream guide plate and the guide roller provided on the downstream side of the downstream guide plate are provided such that the guide rollers rotate in a ganged manner.

5. The image formation apparatus according to claim 1, wherein the upstream guide plate is alone provided with the guide roller.

6. The image formation apparatus according to claim 4, wherein the upstream guide plate has an upstream side provided with the guide roller and also has a downstream side provided with the guide roller.

7. The image formation apparatus according to claim 5, wherein the guide roller provided on the upstream side of the upstream guide plate and the guide roller provided on the downstream side of the upstream guide plate are provided such that the guide rollers rotate in a ganged manner.

8. The image formation apparatus according to claim 1, wherein the downstream guide plate is alone provided with the guide roller.

9. The image formation apparatus according to claim 8, wherein the downstream guide plate has an upstream side provided with the guide roller and also has a downstream side provided with the guide roller.

10. The image formation apparatus according to claim 9, wherein the guide roller provided on the upstream side of the downstream guide plate and the guide roller provided on the downstream side of the downstream guide plate are provided such that the guide rollers rotate in a ganged manner.

11. The image formation apparatus according to claim 1, wherein:
the guide roller is provided to be detachably attachable using a lock member;
in a state where the transport frame is drawn out toward the front side of the body of the image formation apparatus, a state of an attachment of the guide roller by the lock member is cancelled and the guide roller is extractable; and
in a state where the transport frame is accommodated in the body of the image formation apparatus, the state of the attachment of the guide roller by the lock member is maintained and the guide roller is unextractable.
